(19) United States
(12) Patent Application Publication
(10) Pub. No.: US 2015/0193120 A1
(43) Pub. Date: Jul. 9, 2015

(54) SYSTEMS AND METHODS FOR TRANSFORMING A USER INTERFACE ICON INTO AN ENLARGED VIEW

(71) Applicant: AI Squared, Manchester Center, VT (US)

(72) Inventor: Aaron M. Leventhal, Winchester, MA (US)

(73) Assignee: AI Squared, Manchester Center, VT (US)

(21) Appl. No.: 14/592,827

(22) Filed: Jan. 8, 2015

Related U.S. Application Data
(60) Provisional application No. 61/925,404, filed on Jan. 9, 2014.

(51) Int. Cl. G06F 3/0481; G06F 3/0484

(52) U.S. Cl. CPC G06F 3/04817; G06F 3/04842; G06F 3/04847

(57) ABSTRACT

A system is provided, comprising at least one processor and at least one storage having encoded thereon executable instructions that, when executed by the at least one processor, cause the at least one processor to: visually render a first view of at least one user interface element; and in response to detecting a trigger event, cause the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

### RELATED APPLICATIONS

This Application claims priority under 35 U.S.C. §119(e) to U.S. Provisional Application Ser. No. 61/925,404, entitled “TECHNIQUES FOR SCALING A USER INTERFACE ICON INTO AN ENLARGED VIEW” filed on Jan. 9, 2014, which is herein incorporated by reference in its entirety.

### BACKGROUND

Computing devices have become useful tools for communication and information retrieval for a wide range of users. Many everyday activities can now be conducted electronically, such as reading news, paying bills, shopping, etc. Moreover, with the proliferation of network-enabled mobile devices (e.g., smartphones, tablets, laptops, etc.), users can carry out these activities anytime and anywhere.

### SUMMARY

In some embodiments, a system is provided, comprising: at least one processor; and at least one storage having encoded thereon executable instructions that, when executed by the at least one processor, cause the at least one processor to: visually render a first view of at least one user interface element; and in response to detecting a trigger event, cause the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

In some embodiments, the at least one processor is programmed by the executable instructions to render a transition animation of the at least one user interface element growing in size from the first view to the second view.

In some embodiments, the at least one user interface element comprises, at least, a first user interface component and a second user interface component.

In some embodiments, the first and second user interface components are present both in the first view and in the second view. and a relative position between the first and second user interface components in the second view matches a relative position between the first and second user interface components in the first view.

In some embodiments, a distance between the first and second user interface components in the second view is larger than a distance between the first and second user interface components in the first view.

In some embodiments, the second view comprises at least one user interface component that is not visible in the first view.

In some embodiments, the trigger event is a first trigger event, and the at least one processor is further programmed by the executable instructions to, in response to detecting a second trigger event, cause the first view of the at least one user interface element to visually replace the second view of the at least one user interface element.

In some embodiments, the at least one user interface element comprises at least one control, and the at least one processor is further programmed by the executable instructions to visually convey a state of the at least one control in the first view.

In some embodiments, the at least one processor is further programmed by the executable instructions to, in response to a change in the state of the at least one control, update the first view to reflect the state of the at least one control.

In some embodiments, the executable instructions comprises a first set of instructions for rendering the first view and a second set of instructions for rendering the second view, the second set of instructions being independent from the first set of instructions.

In some embodiments, the executable instructions further comprises a third set of instructions for a super view, the first set of instructions programs the at least one processor to render the first view based on the super view in a first manner, and the second set of instructions programs the at least one processor to render the second view based on the super view in a second manner different from the first manner.

In some embodiments, the at least one processor is programmed by the executable instructions to receive, via the second view of the at least one user interface element, user input relating to at least one functionality, and the at least one processor is not programmed to receive, via the first view of the at least one user interface element, user input relating to at least one functionality.

In some embodiments, the at least one processor is programmed to receive, via the first view of the at least one user interface element, only user input to trigger visual replacement of the first view by the second view.

In some embodiments, the at least one processor is programmed to render the first view within a viewport, the viewport comprising at least one visual feature other than the at least one user interface element, and a size of the second view relative to the viewport is larger than a size of the first view relative to the viewport.

In some embodiments, the at least one processor is programmed to cause the first view to be visually replaced by the second view without changing the at least one visual feature other than the at least one user interface element.

In some embodiments, the at least one processor is programmed by the executable instructions to cause the second view to visually obscure the first view.

In some embodiments, the at least one processor is programmed by the executable instructions to, in response to detecting the trigger event, cause at least one intermediate event to occur, and cause the first view to be replaced visually by the second view in response to the at least one intermediate event.

In some embodiments, causing the at least one intermediate event to occur comprising setting a timer to expire after a selected duration of time.

In some embodiments, the at least one user interface element comprises a slider.

In some embodiments, the slider is configured to receive user input to control magnification of displayed text.

In some embodiments, a method performed by at least one processor programmed by executable instructions is provided, the method comprising: visually rendering, on a display device, a first view of at least one user interface element; and in response to detecting a trigger event, causing the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

In some embodiments, at least one computer-readable medium is provided, having encoded thereon executable instructions that, when executed by at least one processor, cause the at least one processor to perform a method comprising: visually rendering, on a display device, a first view of at least one user interface element; and in response to detecting a trigger event, causing the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

### BRIEF DESCRIPTION OF DRAWINGS

FIG. 1A shows an illustrative user interface icon 100, in accordance with some embodiments.

FIG. 1B shows an illustrative user interface panel 150, in accordance with some embodiments.

FIG. 2A shows an illustrative icon view 200 of a user interface element, in accordance with some embodiments.

FIG. 2B shows an illustrative enlarged view 250 that may be presented upon detecting an indication that a user wishes to interact with the user interface element of FIG. 2A, in accordance with some embodiments.

FIG. 2C shows the illustrative enlarged view 250 of FIG. 2B, visually updated to reflect one or more inputs received from a user, in accordance with some embodiments.

FIG. 2D shows the illustrative icon view 200 of FIG. 2A, visually updated to reflect one or more inputs received from a user, in accordance with some embodiments.

FIG. 2E shows another illustrative enlarged view 280 that may be presented upon detecting an indication that a user wishes to interact with the user interface element of FIG. 2A, in accordance with some embodiments.

FIG. 2F shows the illustrative enlarged view 280 of FIG. 2E, visually updated in response to a user activating the button 285, in accordance with some embodiments.

FIG. 3 shows an illustrative system 300 for implementing a user interface element, in accordance with some embodiments.

FIG. 4 shows an illustrative state transition diagram for a user interface element, in accordance with some embodiments.

FIG. 5A shows an illustrative system 500A in which one or more of the inventive concepts described herein may be implemented, in accordance with some embodiments.

FIG. 5B shows another illustrative system 500B in which one or more of the inventive concepts described herein may be implemented, in accordance with some embodiments.

FIG. 5C shows another illustrative system 500C in which one or more of the inventive concepts described herein may be implemented, in accordance with some embodiments.

FIG. 6 shows, schematically, an illustrative computer 1000 on which any aspect of the present disclosure may be implemented.

### DETAILED DESCRIPTION

A graphical user interface allows a user to interact with a computer device by manipulating one or more graphical user interface elements (e.g., icons, menus, buttons, sliders, etc.). For instance, a user may use a pointing device (e.g., a mouse, stylus, touchpad, touchscreen, etc.) to select a user interface element. The user interface element may be activated upon selection, or the user may perform one or more other actions (e.g., mouse clicks, keystrokes, voice commands, etc.) to activate the user interface element.

The inventor has recognized and appreciated that different users may have different abilities in viewing and/or manipulating user interface elements. For example, a user may have reduced vision or dexterity, or may be using a computing device in a context in which the user's vision or dexterity may be temporarily impaired (e.g., dimmed lighting, the user wearing gloves, etc.). Furthermore, some computing devices may have characteristics (e.g., small screens) that may affect a user's ability to view and/or manipulate user interface elements.

The inventor has recognized and appreciated that small user interface elements may present usability challenges. For example, a user may have difficulty seeing, interpreting, and/or interacting with small visual user interface components. Accordingly, it may be desirable to make user interface elements appear larger, so that users with visual impairments may be able to better understand and interact with the user interface, and users with low dexterity may be able to more easily acquire targets via larger user interfaces.

The inventor has recognized and appreciated that a challenge with simply making user interface elements (also referred to as “user interface widgets”) larger is that the user interface elements may be competing for visual space with other features displayed on the user interface (e.g., information presented textually and/or graphically). One approach to improving usability without taking up an excessive amount of visual space may be to present an icon that is small and yet conveys functionality, and that can be activated to reveal a larger panel. For example, the icon may be designed to indicate to a user one or more functions that may be available by interacting with the icon.

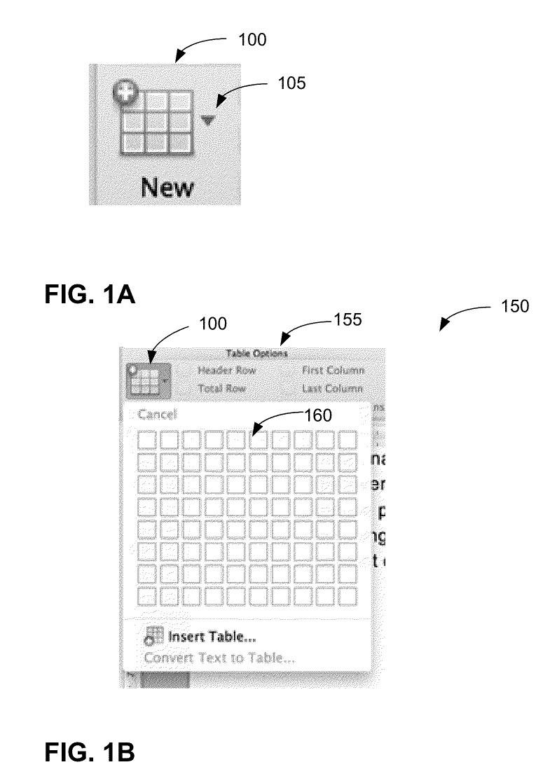

FIG. 1A shows an illustrative user interface icon 100, in accordance with some embodiments. In this example, the illustrative icon 100 is a toolbar item for creating a new table. The icon 100 may be designed to have a visual appearance of a table, which may suggest to a user that the icon 100 may be used to create and/or modify tables. The icon 100 may further include a downward arrow 105, which may provide an affordance that a menu will drop if the icon 100 is clicked, hovered upon, or otherwise activated.

FIG. 1B shows an illustrative user interface panel 150, in accordance with some embodiments. For instance, the panel 150 may be revealed by activating the illustrative icon 100 shown in FIG. 1A. A user may activate the icon 100 in any suitable manner, for example, via a mouse over, click, touch, etc., or by giving the icon 100 focus or providing some other indication.

In some embodiments, the panel 150 may be larger than the icon 100. For instance, in the example of FIG. 1B, the panel 150 may include the icon 100 at the top, as well as additional user interface components such as table options 155 next to the icon 100 and a grid 160 beneath the icon 100. In this manner, the additional user interface components may not take up visual space until the icon 100 is activated by the user.

Although the icon 100 and the panel 150 may be used together to reveal the additional user interface components only when needed and thereby make more visual space available for other features, the inventor has recognized and appreciated some disadvantages of such an approach. For example, the inventor has recognized and appreciated that displaying additional user interface components adjacent to an icon used to reveal the additional user interface components may cause user confusion. For instance, in the example of FIGS. 1A-B, the icon 100 and the grid 160 may both have a table-like appearance that is suggestive of a table creation functionality. Once the icon 100 is activated to reveal the grid 160, the icon 100 may still be displayed, but may be disabled. However, due to the redundancy in visual presentation, a user may be unsure whether the icon 100 may still be used.

One approach to mitigating such user confusion is to make the icon 100 appear visually different from the panel 150, in addition to being smaller than the panel 150. In this manner, the icon 100 may convey an affordance of the panel 150 without directly representing the panel 150. However, the inventor has appreciated that the additional effort needed to create a separate design for the icon 100 may increase costs and/or slow down the design process. It may more convenient to design the icon 100 to be a reduced representation of one or more of the additional user interface components (e.g., the grid 160) that are revealed by activating the icon 100. Furthermore, if the icon 100 bears too little resemblance to the additional user interface components, the suggestive power of the icon 100 may be diminished, and it may be more difficult for a user to discover the additional user interface components. For example, as noted above, the icon 100 may be designed to have an appearance (e.g., a table-like appearance) that is suggestive of a functionality (e.g., creation of a table) that may be accessed by activating the icon 100. On the other hand, the panel 150 may include a user interface component (e.g., the grid 160) for accessing the same functionality and therefore it may be desirable for that user interface component to have a similarly suggestive appearance.

The inventor has recognized and appreciated that the confusion caused by visual redundancy may be exacerbated when an icon conveys state information in a similar manner as an additional user interface component revealed by activation of the icon. For instance, in some embodiments, an icon may include a slider, and may be activated to reveal a similar but larger slider. When the user moves an indicator on the larger slider to change a current value, both sliders may update to show the current value. Thus, the smaller slider in the icon may update even though the user is not interacting with the icon. The user may find such a visual effect strange. If, on the other hand, the smaller slider in the icon is not immediately updated, the user may see two sliders with different indicator positions, which may cause confusion.

The inventor has further recognized and appreciated that as one or more additional user interface components appear upon activation of an icon, a user may need to process the new view and adjust his approach accordingly. If the one or more additional user interface components are displayed adjacent to the icon, additional cognitive processing may be needed on the user's part to understand how the one or more additional user interface components are related to the icon.

Accordingly, in various embodiments described herein, improved techniques are provided to make user interface elements more user friendly and/or easier to design. For instance, in some embodiments, a user interface element may have at least two views: an icon view (also referred to as a “badge”) and an enlarged view (also referred to as a “panel”). The inventor has recognized and appreciated that the two views may be used to achieve a desired tradeoff in the sizing of the user interface element. For instance, a smaller icon view may take up less space and/or distract less from other displayed content, but may be difficult to use for users with reduced vision or dexterity. Accordingly, an enlarged view may be provided that may be easier to use.

In some embodiments, a user interface element may be configured to transform from an icon view into an enlarged view in response to a trigger event. The trigger event may include an indication that a user wishes to interact with the user interface element. For example, when the user interface element is not in use, the icon view of the user interface element may be shown. The user may mouse over, click, touch, give focus to, or otherwise select the user interface element, which may cause the icon view to transform into the enlarged view. When the user is done interacting with the user interface element, the user may so indicate, for example, by moving the pointer away from the user interface element, giving focus to another user interface element, clicking or touching another part of the display, or otherwise deselecting the user interface element. Such an indication may cause the user interface element to return to the icon view. In this manner, the enlarged view may be shown only when the user interface element is in use, thereby freeing up display space for other content.

The inventor has recognized and appreciated that some users may be accustomed to initiating an interaction with a user interface element by first identifying the user interface element as a target of the interaction (e.g., by moving a pointer over, clicking, and/or touching the user interface element) and then performing one or more other actions (e.g., moving a slider, clicking on an available option, etc.). Accordingly, in some embodiments, an identifying action may be used to trigger a transformation from an icon view into an enlarged view. In this manner, a user may use a familiar approach to interact with a user interface element, and an initial action (e.g., moving a pointer over, clicking, and/or touching the user interface element) of the user may transform the user interface element from the icon view, which may be too small for interaction, to the enlarged view, which may be easier for the user to use.

In some embodiments, an icon view of a user interface element may be a reduced version of an enlarged view of the user interface element. This may advantageously reduce the amount of effort needed to design the icon view. As one example, a designer may design the enlarged view, and the icon view may be obtained by simply scaling down the enlarged view, with no additional effort needed on the part of the designer. As another example, a designer may pare down the enlarged view (e.g., by specifying one or more features in the enlarged view that are to remain, or be removed from, the icon view), and the icon view may be obtained by scaling down the pared down version of the enlarged view. This latter approach may result in an icon view that is less cluttered and therefore easier to understand and/or more visually appealing. However, it should be appreciated that aspects of the present disclosure are not limited to the construction of an icon view by paring down an enlarged view.

Furthermore, in some embodiments, one or more aspects of programmatic implementation may be shared between an icon view and an enlarged view of a user interface element, which may advantageously reduce the amount of effort needed for development. For example, the icon view and the enlarged view may be updated in the same manner to show a state of the user interface element (e.g., a position of an indicator on a slider, a pressed or not pressed state of a toggle button, etc.). However, it should be appreciated that aspects of the present disclosure are not limited to the use of an icon view or an enlarged view that is configured to show state information.

In some embodiments, one or more cues may be provided to signal to a user that an icon view and an enlarged view are related to each other (e.g., as two different views of the same user interface element). For example, a transition animation may be rendered to show a user interface element growing in size from an icon view to an enlarged view, so that the user may readily recognize that both views represent the same user interface element. In this manner, less cognitive processing may be needed, because the user need not process the enlarged view as a separate object and then make an inference that the enlarged view is related to the icon view. Furthermore, the user may already be somewhat familiar with the icon view and may know, at least partially, what to expect as the icon view grows into the enlarged view. However, it should be appreciated that aspects of the present disclosure are not limited to the use of a transition animation, or any cue at all.

It should be appreciated that the concepts introduced above and discussed in greater detail below may be implemented in any of numerous ways, as the disclosed concepts are not limited to any particular manner of implementation. The examples shown in the figures and described herein are provided solely for illustrative purposes.

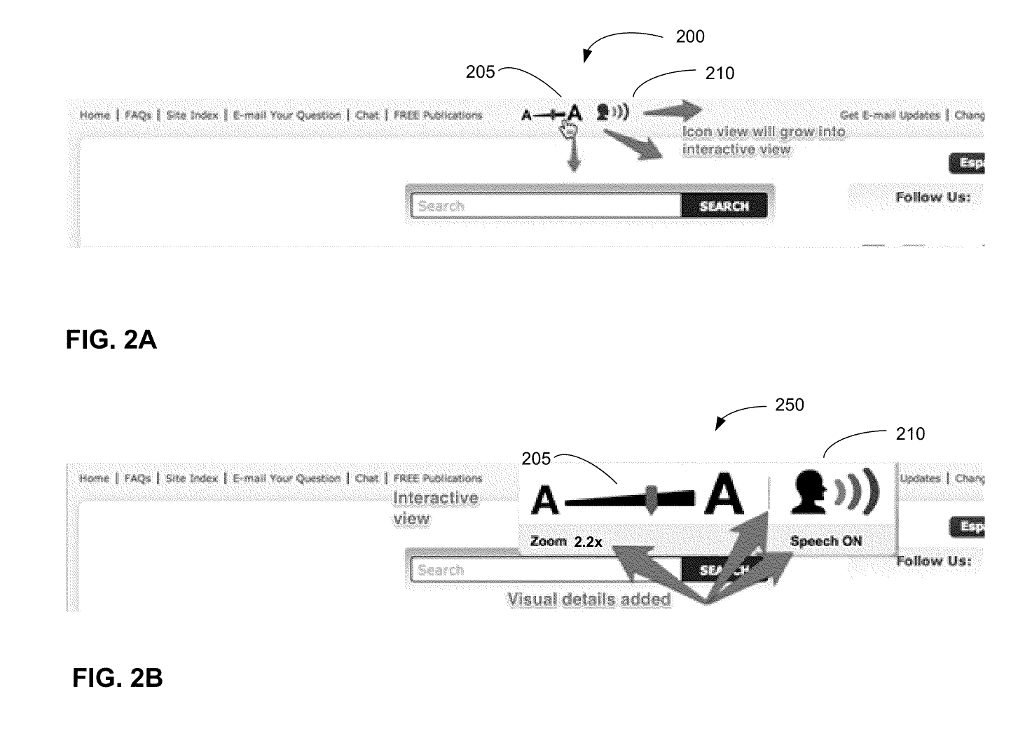

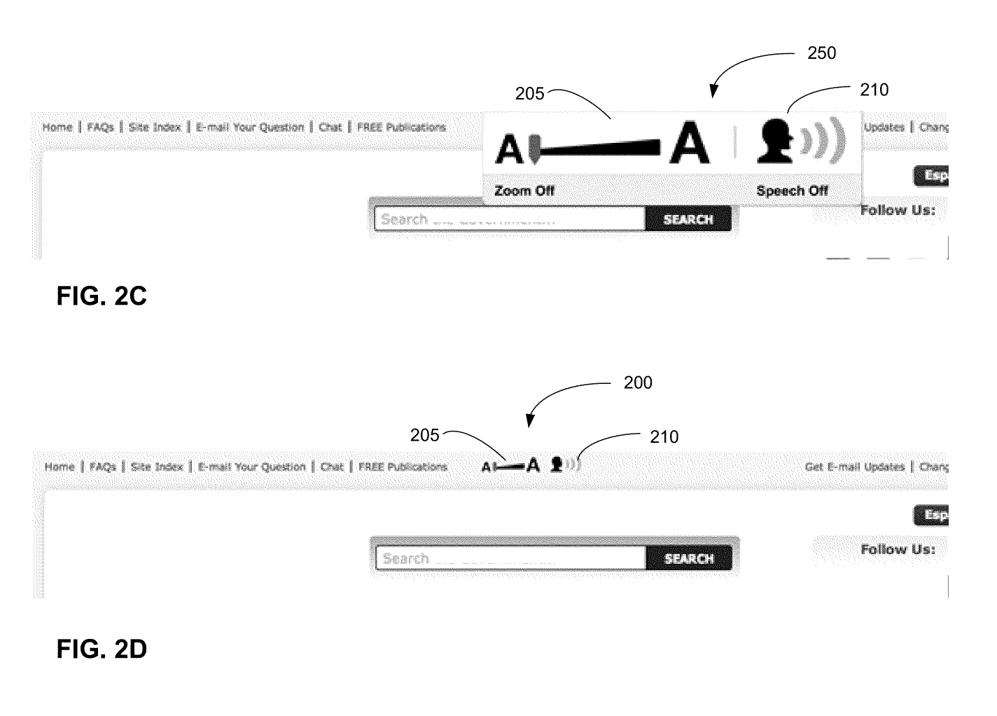

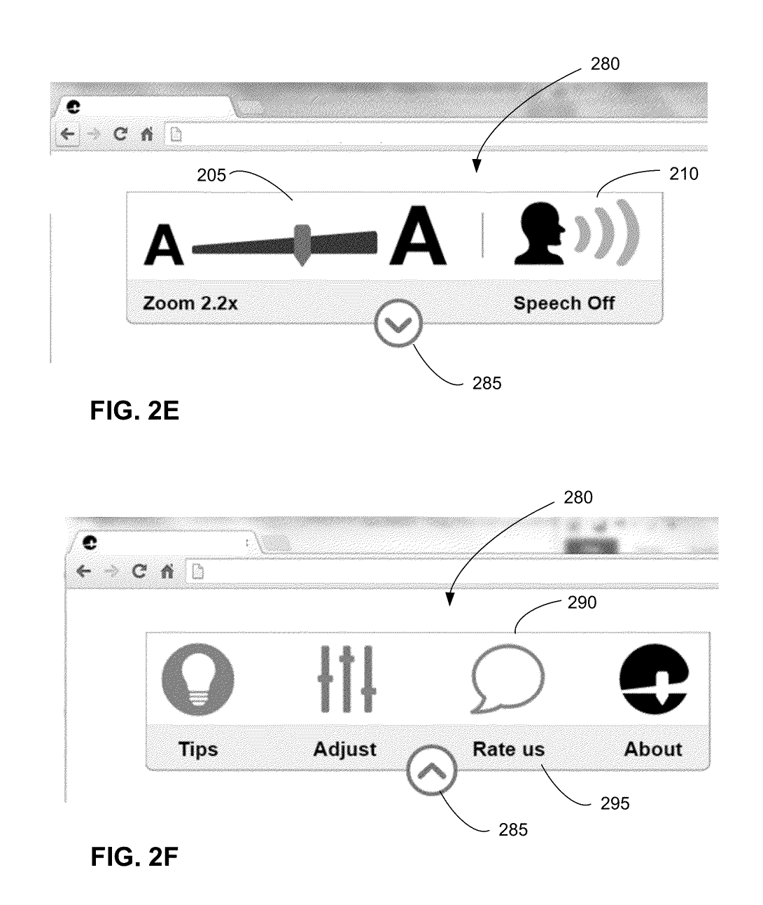

FIG. 2A shows an illustrative icon view 200 of a user interface element, in accordance with some embodiments. In this example, the user interface element includes two components: a slider 205 and a button 210. The slider 205 may have a letter (e.g., the letter “A”) disposed on either side, with one letter larger than the other. This arrangement may suggest to a user that the slider 205 may be used to increase or decrease the font size of displayed text. The button 210 may include the silhouette of a person's head disposed adjacent to concentric arcs representing sound waves. This arrangement may suggest to a user that the button 210 may be used to turn on or off a text-to-speech functionality.

In some embodiments, the icon view 200 may be shown when the user interface element is not in use. To activate the user interface element, a user may hover a pointer over, click, touch, give focus to, or otherwise interact with the icon view 200, which may cause the icon view 200 to transform into an enlarged view. For example, a transition animation may be rendered to show the icon view 200 growing into the enlarged view.

FIG. 2B shows an illustrative enlarged view 250 that may be presented upon detecting an indication that a user wishes to interact with the user interface element of FIG. 2A, in accordance with some embodiments. In this example, the enlarged view 250 is an expanded version of the icon view 200 shown in FIG. 2A. The slider 205 and the button 210 may be arranged in the same manner in the enlarged view 250 as in the icon view 200 (e.g., the slider 205 to the left of the button 210). In some embodiments, the slider 205 and/or the button 210 may appear larger in the enlarged view 250 than in the icon view 200. Additionally, or alternatively, the slider 205 and the button 210 may be further spaced apart in the enlarged view 250 than in the icon view 200.

As discussed above, presenting an enlarged view that is an expanded version of an icon view may have various advantages, such as ease of implementation and/or reduced cognitive load on users. However, it should be appreciated that aspects of the present disclosure are not limited to the use of an enlarged view that is an expanded version of an icon view.

In the example shown in FIG. 2B, the enlarged view 250 includes additional visual details that are not present in the icon view 200 of FIG. 2A. As one example, a vertical bar may be inserted between the slider 205 and the button 210. This may indicate to a user that the slider 205 and the button 210 are two separate components with distinct functionalities. As another example, textual explanation may be added to the slider 205 and/or the button 210. For instance, a current value of the slider 205 (e.g., “2.2× ”magnification) and a current state of the button 210 (e.g., text-to-speech “On”) may be displayed. These labels may assist a user in understanding and/or accessing the functionalities provided by the slider 205 and the button 210. However, it should be appreciated that aspects of the present disclosure are not limited to the use of an enlarged view with additional visual details. Additionally, although in the example of FIGS. 2A-B the enlarged view 250 may be interactive while the icon view 200 may be non-interactive, it should be appreciated that in some embodiments an icon view may also provide at least some level of interactivity, including, but not limited to, the same level of interactivity as an enlarged view.

The inventive concepts described herein may be used to provide improved user interface elements in any suitable context. For instance, in the example shown in FIGS. 2A-B, a user interface element is provided for a web page (e.g., to allow a user to change the font size of displayed text, and/or to listen to speech generated from textual content). However, it should be appreciated that aspects of the present disclosure are not limited to use with user interface elements on web pages. Other settings may also benefit from the techniques described herein, such as having an icon view that, upon activation, transforms into an enlarged view (e.g., with a transition animation). Examples of other settings include, but are not limited to, a toolbar dock on a desktop or mobile system that provides easy access to applications and/or features, a toolbar in a desktop or mobile application, etc.

FIG. 2C shows the illustrative enlarged view 250 of FIG. 2B, visually updated to reflect one or more inputs received from a user, in accordance with some embodiments. For example, as the user works in the enlarged view 250, the user may move the indicator on the slider 205 to the far left, which may turn off the zoom functionality and return the displayed text to a default font size. In response, the enlarged view 250 may be updated to show the new position of the indicator and/or to display the new slider value textually (e.g., “Zoom Off”). Furthermore, the user may toggle the button 210 to the “Off” position, which may turn off the speech-to-text functionality. In response, the enlarged view 250 may be updated to convey the “Off” state of the button 210, for example, by changing the color of the concentric arcs representing sound waves (e.g., from colored to grayscale) and/or displaying the state textually (e.g., text-to-speech “Off”). Other ways to convey the state of a user interface element may also be used, including, but not limited to, techniques based on audible signals, tactile signals, etc.

FIG. 2D shows the illustrative icon view 200 of FIG. 2A, visually updated to reflect one or more inputs received from a user, in accordance with some embodiments. For example, when the user is done working in the enlarged view 250, the user may navigate outside of the enlarged view 250 (e.g., by moving the pointer away from the enlarged view 250, giving focus to another user interface element, clicking or touching another part of the display, or otherwise deselecting the user interface element). In response to such an indication, or the occurrence of some other event, the enlarged view 250 may collapse into the icon view 200. In this manner, some of the display space occupied by the enlarged view 250 may be freed up for other content when the user no longer needs the enlarged view 250.

In some embodiments, one or more updates made while the user was interacting with an enlarged view may be shown in a corresponding icon view after the enlarged view collapses into the icon view. For instance, in the example of FIG. 2D, the icon view 200 may show the indicator on the slider 205 being on the far left and the concentric arcs of the button 210 being grayed out. The inventor has recognized and appreciated that updating an icon view to reflect the current state of a user interface element may advantageously allow a user with sufficiently high visual acuity to quickly see the current state, without having to trigger an enlarged view. If the user has low dexterity, the user may trigger and interact with an enlarged view when needed. On the other hand, a user with low visual acuity may trigger the enlarged view to see the current state of the user interface element.

In some embodiments, a transition from an icon view to an enlarged view and/or from an enlarged view to an icon view may be animated. For example, rather than the enlarged view suddenly appearing or fading in, a transition animation may show the icon view growing into the enlarged view. Additionally, or alternatively, a transition animation may show the enlarged view shrinking into the icon view, as opposed to the enlarged view suddenly disappearing or fading out. Any suitable transition animation may be used, as aspects of the present disclosure are not limited to the use of any particular animation technique.

The inventor has recognized and appreciated that a transition animation may advantageously provide perceived continuity between two views, which may allow a user to infer, with reduced effort, that the two views are associated with the same user interface element. For example, the transition animation may help a user develop a mental model of the two views as differently sized versions of the same object. However, it should be appreciated that aspects of the present disclosure are not limited to the use of a transition animation.

FIG. 2E shows another illustrative enlarged view 280 that may be presented upon detecting an indication that a user wishes to interact with the user interface element of FIG. 2A, in accordance with some embodiments. Like the illustrative enlarged view 250 shown in FIG. 2B, the enlarged view 280 may be an expanded version of the icon view 200 shown in FIG. 2A.

In some embodiments, the enlarged view 280 may include additional visual details that are not present in the icon view 200 of FIG. 2A. For example, the enlarged view 280 may include a button 285, which may be rendered with one or more features to suggest that additional options may be accessed by activating the button 285. For instance, in the example shown in FIG. 2E, the enlarged view 280 includes a downward-pointing chevron , which may provide an affordance that a menu will drop if the button 285 is clicked, hovered upon, or otherwise activated.

FIG. 2F shows the illustrative enlarged view 280 of FIG. 2E, visually updated in response to a user activating the button 285, in accordance with some embodiments. In this example, in response to the user activating the button 285, one or more components of the enlarged view 280 (e.g., the slider 205 and/or the button 210) may be replaced with one or more other components (e.g., an icon 290 and a text label 295). The inventor has recognized and appreciated that replacing some components with other components may advantageously make more options available to the user without taking up additional visual space. However, it should be appreciated that aspects of the present disclosure are not limited to the replacement of user interface components in any view.

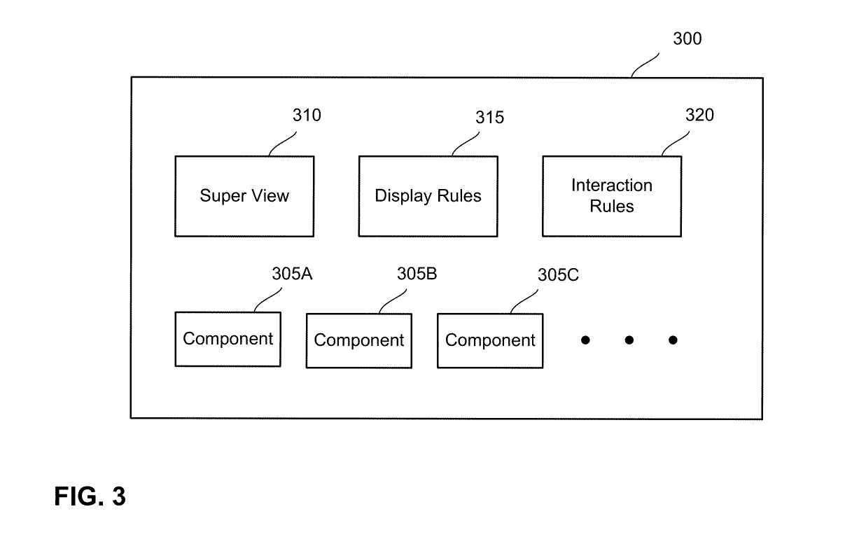

FIG. 3 shows an illustrative system 300 for implementing a user interface element, in accordance with some embodiments. For instance, the system 300 may be used to present the illustrative icon view 200 and the illustrative enlarged view 250 shown in FIGS. 2A-D.

In the example shown in FIG. 3, the system 300 includes a plurality of user interface components 305A, 305B, 305C, . . . Each of these user interface components may be rendered in one or more views of a user interface element. For instance, with reference to the example of FIGS. 2A-D, there may be user interface components corresponding to the slider 205, the button 210, the text label associated with the slider 205, the text label associated with the button 210, and the separator between the slider 205 and the button 210, respectively. Other types of user interface components may be specified in addition to, or instead of, those shown in FIGS. 2A-D, such as text fields, menus, borders, shading effects, shadows, etc. Furthermore, aspects of the present disclosure are not limited to the use of multiple user interface components, as in some embodiments a user interface element may be provided that consists of a single component. In some embodiments, visual features such as borders, shading effects, shadows, etc. may be implemented as one or more properties of the single component.

The illustrative user interface components 305A, 305B, 305C, . . . may be provided in any suitable manner. For instance, in some embodiments, a user interface designer may specify one or more of the user interface components using a suitable graphical format. Alternatively, or additionally, one or more of the user interface components may be generated by a software program, with or without a designer's input.

The inventor has recognized and appreciated that it may be desirable to use a graphical format that allows transformations to be performed easily, such as changing one or more dimensions (e.g., length, width, depth, diameter, height, etc.) of a user interface component, rotating a user interface component along one or more axes, rearranging two or more user interface components relative to each other, etc. The inventor has recognized and appreciated that the ability to perform transformations easily may be particularly desirable for a user interface element that is to be delivered via a web page. Examples of suitable formats include, but are not limited to, SVG (Scalable Vector Graphics), HTML (HyperText Markup Language), CSS (Cascading Style Sheet), etc. However, it should be appreciated that aspects of the present disclosure are not limited to the use of any particular format or combination of formats.

In some embodiments, the illustrative system 300 of FIG. 3 may include a super view 310, which may specify how the user interface components 305A, 305B, 305C, . . . may be arranged. The super view 310 may include all components of the user interface element, and may be a logical view that may or may not correspond to a view to be presented to users. For instance, in some embodiments, it may be that every view to be presented to users is missing one or more of the user interface components. Such a view may, in some embodiments, be obtained from the super view 310 by specifying which one or more of the user interface components are to be omitted. By contrast, a super view for the illustrative user interface element of FIGS. 2A-D may correspond to the enlarged view 250, which may include all components of the user interface element (e.g., the components shown in the enlarged view 250 may be a superset of the components shown in the icon view 200).

Although the inventor has recognized and appreciated various advantages of using a super view (e.g., ease of deriving other views by hiding one or more components from the super view), it should be appreciated that aspects of the present disclosure are not so limited. For instance, in some embodiments, a view may be defined at least in part by specifying one or more components to be shown in that view and/or how the one or more components are to be arranged, without using any super view.

In some embodiments, the illustrative system 300 of FIG. 3 may include one or more display rules 315. For instance, a display rule may specify whether and/or how a certain user interface component is to appear in a certain view. Further examples of display rules are discussed in detail below. However, it should be appreciated that aspects of the present disclosure are not limited to the use of any particular display rule or combination of display rules. Moreover, display rules may be implemented in any suitable way (e.g., as executable code written in a style language such as CSS, or in another suitable language).

In some embodiments, a display rule may be provided that can be used to determine whether to show or hide a user interface component in a view. As one example, a display rule may specify which user interface components are to appear in a certain view and/or how those user interface components are to be arranged in that view. For instance, with reference to the example shown in FIGS. 2A-D, a display rule may specify that one or more borders, shading effects, text labels and/or separators are to be shown in the enlarged view 250. Alternatively, or additionally, the display rule may specify that the one or more borders, shading effects, text labels and/or separators are not to be shown in the icon view 200.

As another example, a user interface component may be tagged according to one or more views (e.g., full, large, small, etc.) in which the component is to appear, and a display rule may use the tagging information to determine whether to show the user interface component in a certain view. As another example, user interface components may be assigned priority values, and a display rule may be used to determine whether to show a user interface component in a view based on a priority value associated with the component. For instance, in some embodiments, a view may be associated with a priority threshold, and components having priority values above the threshold may be shown, while components having priority values below the threshold may be hidden. Such thresholds may be selected in any suitable manner. For example, smaller views may be associated with higher thresholds, so that components associated with lower priority values may be gradually removed to make room in smaller and smaller views. However, it should be appreciated that aspects of the present disclosure are not limited to any particular way of selecting thresholds, or to the use of thresholds to determine whether to show or hide user interface components.

In some embodiments, a display rule may be provided that can be used to determine one or more dimensions for a user interface component. For instance, with reference to the example shown in FIGS. 2A-D, a display rule may specify the dimensions for the slider 205 to be 50 pixels by 15 pixels in the icon view 200, and 300 pixels by 60 pixels in the enlarged view 250. Another display rule may specify the dimensions for the button 210 to be 20 pixels by 20 pixels in the icon view 200, and 80 pixels by 80 pixels in the enlarged view 250. Thus, the aspect ratio of a component may not remain the same from one view to another (e.g., the slider 205 may appear relatively longer in the enlarged view 250).

In some embodiments, a display rule may be provided that can be used to determine a location on a display where a user interface component is to be rendered. For example, a default rule may specify a change in position that is proportional to a change in size (e.g., a positional offset of 10 pixels may automatically become 20 pixels at 2× scaling from an icon view to an enlarged view). The inventor has recognized and appreciated that such default positional scaling, although simple to implement, may or may not be appropriate for a given user interface element. In some instances, one or more components of a user interface element may be shifted around as the user interface element transforms from one view to another. Such adjustments may be done for various reasons, for example, to provide a desired look and feel and/or to accommodate one or more changes to the components.

For instance, with reference to the example shown in FIGS. 2A-D, the slider 205 may be relatively lengthened in the enlarged view 250, compared to the icon view 200. Accordingly, the button 210 may be shifted further to the right to avoid an overlap between the slider 205 and the button 210. For example, a display rule may specify that the button 210 is located at the position <60 pixels, 3 pixels> in the icon view 200, and at the position <450 pixels, 12 pixels> in the enlarged view 250. Thus, the horizontal offset may increase by a factor of 7.5 from the icon view 200 to the enlarged view 250, whereas the vertical offset may increase only by a factor of 4. However, it should be appreciated that positional adjustments are not required, as in some embodiments proportional scaling may be appropriate (e.g., by assigning a CSS transform that scales an object to reduce or increase the object's size). The proportional scaling approach may advantageously reduce or eliminated the need for custom specified rules, while maintaining all user interface components and layout of an enlarged view.

Furthermore, it should be appreciated that the dimensions and offsets described herein are provided solely for purposes of illustration and are not limiting, as any of the user interface components described herein may be rendered in any appropriate size and at any appropriate position. For example, the size of an icon view and/or the size of an enlarged view may be adjusted according to the amount of space available and/or user preferences. In some embodiments, a display rule relating to the size and/or position of a user interface component may utilize units relative to a current view size. Thus, a designer may simply specify an overall size for a view, without having to specify sizes and positions for individual user interface components.

In some embodiments, a display rule may be provided that can be used to determine whether and/or how a transition animation is to be rendered, as a view of a user interface element transforms into another view. As one example, for a component that is present in both views, a transition animation may show the component changing in appearance (e.g., growing, shrinking, and/or deforming) and/or being moved to a different position. As another example, for a component that is present only in one view, a transition animation may show the component fading in or out. Such a transition animation may be implemented in any suitable manner, for example, via executable code (e.g., in JavaScript or some other suitable language) and/or declared style rules (e.g., in CSS or some other suitable format).

In some embodiments, a display rule may be provided that can be used to determine whether and/or how to display state information for a user interface element. For instance, with reference to the example shown in FIGS. 2A-D, the concentric arcs representing sound waves may be shown in color when the button 210 is in an “On” state, and in grayscale when the button 210 is in an “Off” state. Additionally, or alternatively, content of the text label associated with the button 210 may be updated in response to the button 210 being toggled.

The inventor has recognized and appreciated that it may be desirable to maintain user interface (UI) state information (e.g., by maintaining a variable that is used to determine whether to show the sound waves in color or grayscale). Such UI state information may be separate from functional state information (e.g., the value of a variable that is used to determine whether to perform text-to-speech processing). For example, UI state information may be used by software that presents a user interface (e.g., on the browser side), whereas functional state information may be used by software that provides the underlying functionality (e.g., on the server side). However, it should be appreciated that aspects of the present disclosure are not limited to the maintenance of UI state information separately from functional state information, as in some embodiments the same state information may be used for both purposes.

The inventor has recognized and appreciated that a benefit of maintaining UI state information may be that the UI state information may be readily available for use in rendering different views. For instance, in some embodiments, a same set of UI state information may be maintained regardless of which view is current (e.g., an icon view or an enlarged view) and may be made available to display rules for all views. For example, the content of the text label associated with the illustrative button 210 shown in FIGS. 2A-D may be updated when an input is received to toggle the button 210 while the icon view 200 is shown, even if the text label is not shown in the icon view 200. In this manner, when the user wishes to trigger the enlarged view 250, the content of the text label may simply be retrieved and displayed. No additional updating may be needed, which may simplify implementation.

The inventor has further recognized and appreciated that maintaining UI state information may advantageously decouple software for processing inputs from software for presenting a user interface. For instance, in some embodiments, UI state information may be stored and updated in a consistent manner, agnostic to why a state change is occurring (e.g., due to a user input or an external event such as an input received from some other software, a notification from an operating system, a message arriving via a network, etc.). For example, an update to the content of the text label associated with the illustrative button 210 shown in FIGS. 2A-D may be triggered by any of the following: a user clicking on the button 210, a user pressing a global speech button key (which may cause an operating system to issue a notification), browser preferences being loaded, etc. A display rule for a current view may then be executed based on the updated UI state information. This approach may be used to handle all causes for a state change in all potential views where the state change may be rendered. However, it should be appreciated that aspects of the present disclosure are not limited to the decoupling between inputs and display updates, as in some embodiments a display update may be triggered directly by an input.

In some embodiments, executing a display rule may or may not cause a display update. For instance, updating the content of the text label while the icon view 200 is shown may not cause a display update because the text label is not shown in the icon view 200 (although the same input that triggered the update may also trigger an update to a color setting, which may in turn cause a display update that changes the sound waves from being colored to being in grayscale, or vice versa). In this manner, display updates are performed based on internal events that represent changes to a model of a user interface element, rather than being tied directly to input events. This decoupling may advantageously allow a designer to focus on how to convey state information, and not be concerned with the various ways in which a state change may be triggered (which may be the responsibility of another member of the development team). However, it should be appreciated that aspects of the present disclosure are not limited to such decoupling, as in some embodiments display updates may be triggered directly by input events.

Returning to FIG. 3, the illustrative system 300 may, in some embodiments, include one or more interaction rules 320. For instance, an interaction rule may specify whether and/or how a user may interact with a certain user interface component in a certain view. For example, in some embodiments, an enlarged view may allow a complete set of interactions, whereas an icon view may allow only a limited set of interactions (e.g., serving only as a launch point for the enlarged view), or no interaction at all.

In some embodiments, an interaction rule may be provided that specifies how a user may cause an icon view to transform into an enlarged view, or vice versa. For instance, when an icon view of a user interface element is shown, a user may mouse over, click, touch, give focus to, or otherwise select the user interface element, which may cause the icon view to morph into an enlarged view. Additionally, or alternatively, when the enlarged view is shown, the user may navigate away from the enlarged view using any input device (e.g., mouse, keyboard, touchscreen, etc.), which may cause the enlarged view to morph into the icon view.

In some embodiments, an interaction rule may be provided that specifies how a user interface element may behave in response to user and/or other input. For instance, with reference to the example shown in FIGS. 2A-D, a user may move the indicator along the slider 205 (e.g., using a pointing device such as a mouse or touchscreen). In response, an interaction rule may be executed, for example, to identify a new position of the indicator, calculate a new magnification factor according to the new position of the indicator, cause magnification of displayed text according to the new magnification factor, and/or cause a display update to reflect the new position of the indicator (e.g., by updating UI state information associated with the slider 205, which may in turn cause an appropriate display rule to be executed).

It should be appreciated that the examples of display rules and interaction rules discussed above are merely illustrative. Other display and/or interaction rules may be used instead of, or in addition to, those discussed above, as aspects of the present disclosure are not limited to the use of any particular rule or combination of rules.

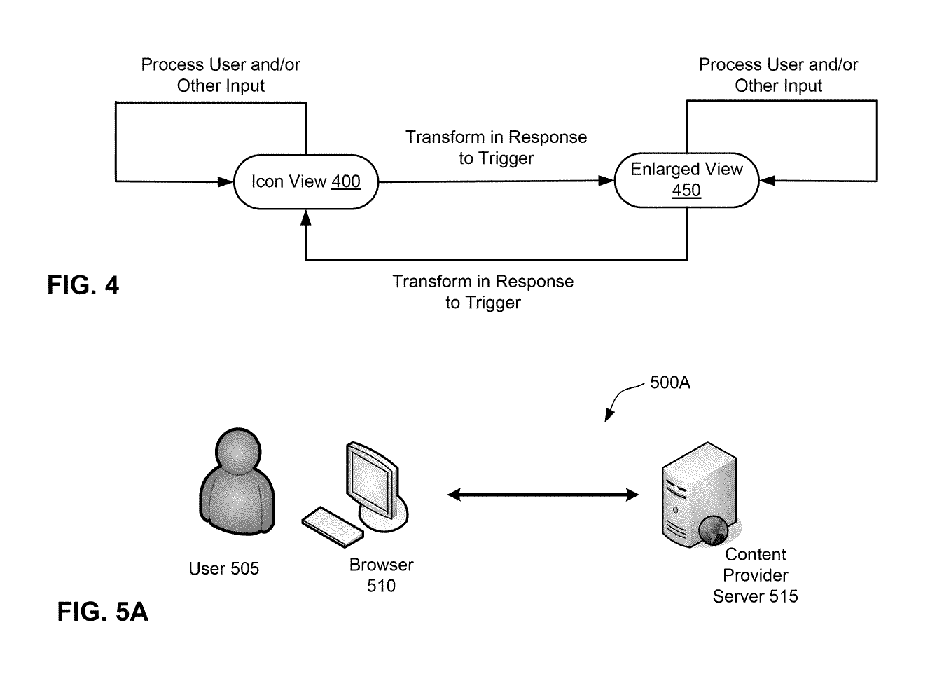

FIG. 4 shows an illustrative state transition diagram for a user interface element, in accordance with some embodiments. Each state in this diagram may correspond to a different view of the user interface element. For instance, as shown in FIG. 4, the user interface element may have two views: an icon view 400 and an enlarged view 450. In some embodiments, the user interface element may be launched into the icon view 400 by default. However, that is not required, as in some embodiments the user interface element may instead be launched into the enlarged view 450 by default, or a user may configure the user interface element to be launched into a view selected by the user.

In some embodiments, each view may have associated therewith one or more transitions. Each transition may be triggered by any suitable event or combination of events, and may involve execution of one or more interaction rules and/or display rules. For example, there may be a transition from the icon view 400 to the enlarged view 450, and vice versa. A transition from the icon view 400 to the enlarged view 450 may involve execution of an interaction rule that specifies how a user may cause the icon view 400 to transform into the enlarged view 450, a display rule that specifies which user interface components are to appear in the enlarged view 450, a display rule that specifies one or more dimensions for a user interface component in the enlarged view 450, a display rule that specifies one or more positional offsets for the user interface component in the enlarged view 450, a display rule that specifies how to convey state information to a user, a display rule that specifies a transition animation from the icon view 400 to the enlarged view 450, etc. A transition from the enlarged view 450 to the icon view 400 may involve execution of similar rules.

In some embodiments, a transition may be provided that is a self-loop. Such a transition may involve execution of an interaction rule that specifies how the user interface element may behave in response to user and/or other input, a display rule that specifies how to convey state information to a user, etc.

It should be appreciated that the examples of views and transitions discussed above in connection with FIG. 4 are merely illustrative. A user interface element may have one or more other views instead of, or in addition to, an icon view and an enlarged view. Moreover, a view may have any suitable combination of one or more transitions, which may or may not include a self-loop.

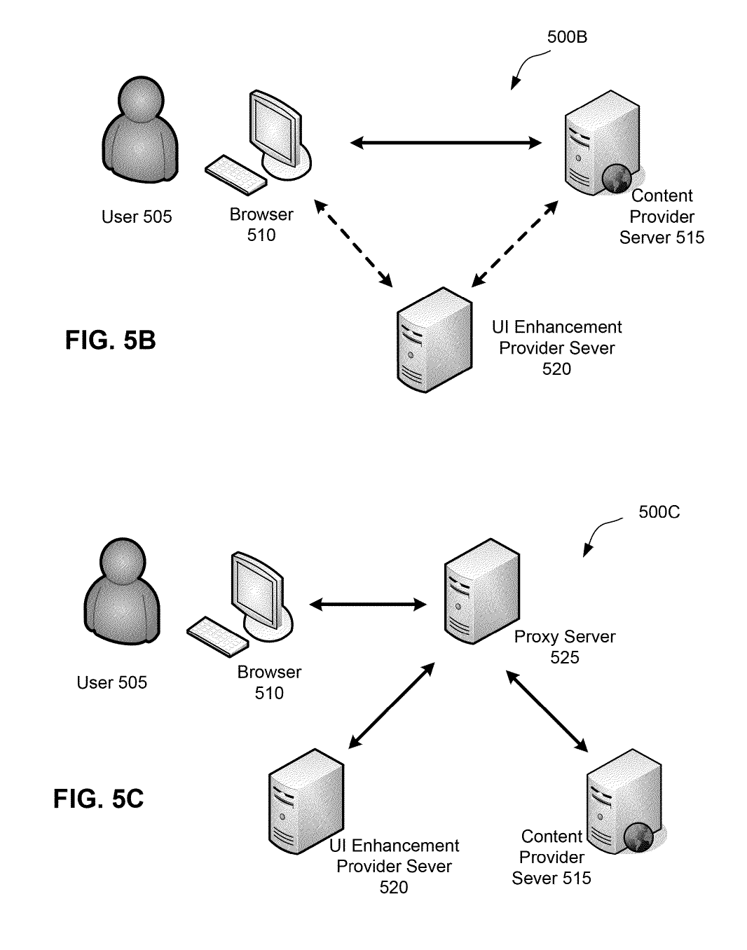

FIG. 5A shows an illustrative system 500A in which one or more of the inventive concepts described herein may be implemented, in accordance with some embodiments. For instance, the system 500A may be used to provide the illustrative user interface element shown in FIGS. 2A-D. In this example, a user 505 may use a browser 510 to view and/or interact with a web page loaded from a content provider server 515. The web page may include UI enhancement software that, when executed by the browser 510, implement the user interface element shown in FIGS. 2A-D. The UI enhancement software may be written in any suitable language, including, but not limited to, JavaScript, HTML, and/or CSS.

In some embodiments, the UI enhancement software implementing a user interface element may be provided by a third party UI enhancement provider. A content provider may build a web page with a placeholder to identify where on the rendered web page the user interface element is to appear and/or how the user interface element may interact with other features on the web page. For example, the placeholder maybe in the form of an HTML element with a suitable identification (ID). Furthermore, the content provider may configure the web page (e.g., by including in the web page a suitable HTML script) to cause the browser 510 to load the UI enhancement software.

FIG. 5B shows another illustrative system 500B in which one or more of the inventive concepts described herein may be implemented, in accordance with some embodiments. In this example, the UI enhancement software may be requested from a UI enhancement provider server 520 when the browser 510 loads a web page from the content provider server 515 (as opposed to the content provider obtaining the UI enhancement software ahead of time and providing the UI enhancement software to the browser 510 without the third party UI enhancement provider's involvement). In some embodiments, the web page may be configured to instruct the browser 510 to request the UI enhancement software directly from the UI enhancement provider server 520. In some embodiments, the content provider server 515 may be configured to request the UI enhancement software from the UI enhancement provider server 520 and then forward the UI enhancement software to the browser 510.

The inventor has recognized and appreciated that requesting UI enhancement software from a UI enhancement software provider when a web page is loaded may simplify maintenance for the content provider. For example, the content provider need not be concerned with obtaining updates for the UI enhancement software and making the most up-to-date version available to users. However, it should be appreciated that aspects of the present disclosure are not limited to the use of a real time request for UI enhancement software from a UI enhancement software provider.

FIG. 5C shows another illustrative system 500C in which one or more of the inventive concepts described herein may be implemented, in accordance with some embodiments. In this example, the browser 510 may be configured to request a web page from the content provider server 515 via a proxy server 525. The proxy server 525 may be configured to request the UI enhancement software from the UI enhancement provider server 520 and then provide the UI enhancement software to the browser 510 along with the requested web page.

In some embodiments, the proxy server 525 may be a forward proxy configured to receive requests from one or more client computers (e.g., a computer on which the browser 510 is running) and access any resource from the Internet on behalf of the one or more client computers. In this manner, the proxy server 525 may be used to augment any web page with the UI enhancement software (e.g., without the content provider building the web page to cause the browser 510 to obtain and load the UI enhancement software).

In some embodiments, the proxy server 525 may be a reverse proxy configured to receive requests from any client over the Internet and to respond to the requests on behalf of one or more servers (e.g., the UI enhancement provider server 520 and/or the content provider server 515). For instance, a content provider may build a web page to include a designated button (or any other suitable user interface element) that a user may activate to receive a link, or to share the link with another user. The recipient may use the link to access the reverse proxy, which may respond with a web page along with the UI enhancement software.

Once loaded, the UI enhancement software may, in some embodiments, be configured to restore previous and/or default user settings. Examples of user settings include, but are not limited to, text magnification factor, text-to-speech preference (e.g., voice characteristics such as gender, age, accent, etc., volume, reading speed, etc.). For instance, the UI enhancement software may look for user settings in a local storage area (e.g., an HTML 5 local storage associated with the content provider or the third party UI enhancement provider). Alternatively, or additionally, user settings may be stored on a server, and the UI enhancement software may be configured to retrieve the settings using one or more cookies stored in the browser 510. The server may be a server of the content provider (e.g., the content provider server 515), a server of the third party UI enhancement provider (e.g., the UI enhancement provider server 520), or any other suitable server.

Although various techniques are described above for providing UI enhancement with a web page, it should be appreciated that such techniques are merely illustrative, and that other suitable techniques may be used instead of, or in combination with, the techniques described above. As one example, UI enhancement software may be provided via a browser extension, which may advantageously make the UI enhancement software available for use with any web site. As another example, UI enhancement software may be incorporated into a browser as a native functionality.

As another example, one or more network settings in an operating system may be modified, so that all web requests (or some filtered set of web requests) are routed through a proxy configured to deliver the UI enhancement software. In this manner, the UI enhancement software may be made available for any web site via any browser.

As another example, UI enhancement software may be integrated with a third party software application, such as an application designed to magnify and/or read displayed text (e.g., email, documents, web pages, etc.). For instance, the third party software application may use the UI enhancement software in a web view. In some embodiments, the third party software application may be configured to modify (e.g., during installation) one or more operating system network settings to route web requests through a proxy configured to deliver the UI enhancement software, so that a user need not manually modify the settings.

It should be appreciated that the foregoing description is by way of example only, and aspects of the present disclosure are not limited to providing any or all of the above-described functionalities, although some embodiments may provide some or all of the functionalities described herein. Furthermore, aspects of the present disclosure may be implemented in any of numerous ways, and are not limited to any particular implementation techniques. Thus, while examples of implementation techniques are described above, it should be appreciated that the examples are provided merely for purposes of illustration, and that other implementations are possible.

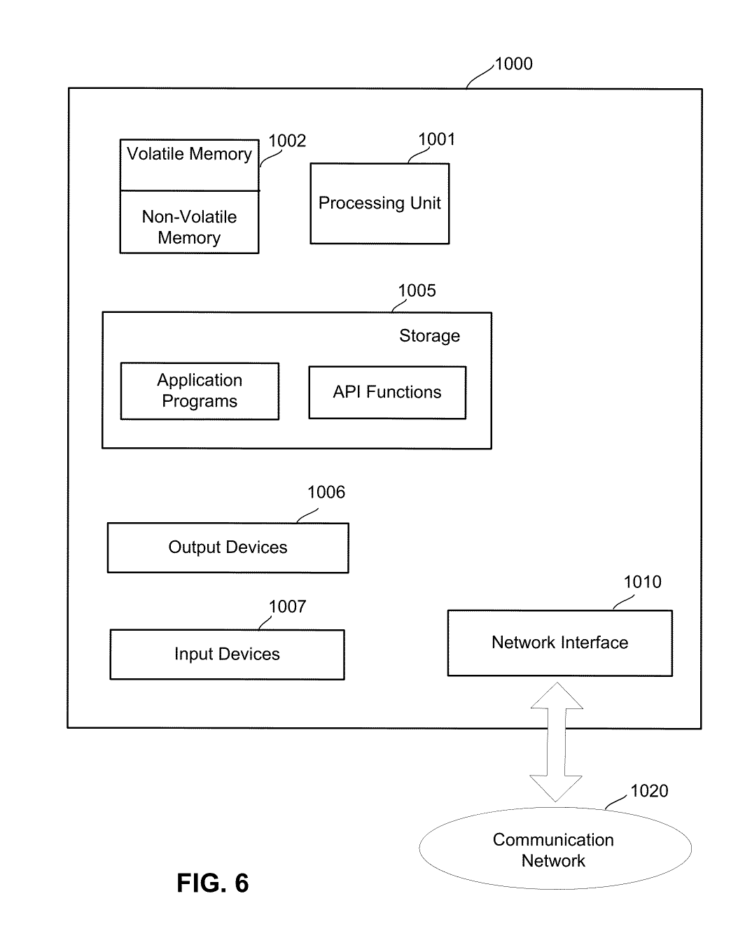

FIG. 6 shows, schematically, an illustrative computer 1000 on which any aspect of the present disclosure may be implemented. For example, the computer 1000 may be a mobile device on which any of the features described in connection with the illustrative user interface element shown in FIGS. 2A-D may be implemented. The computer 1000 may also be used in implementing a server (e.g., one or more of the illustrative servers shown in FIGS. 5A-C) or some other component of a system in which any of the concepts described herein may be implemented.

As used herein, a “mobile device” may be any computing device that is sufficiently small so that it may be carried by a user (e.g., held in a hand of the user). Examples of mobile devices include, but are not limited to, mobile phones, pagers, portable media players, e-book readers, handheld game consoles, personal digital assistants (PDAs), and tablet computers. In some instances, the weight of a mobile device may be at most one pound, one and a half pounds, or two pounds, and/or the largest dimension of a mobile device may be at most six inches, nine inches, or one foot. Additionally, a mobile device may include features that enable the user to use the device at diverse locations. For example, a mobile device may include a power storage (e.g., battery) so that it may be used for some duration without being plugged into a power outlet. As another example, a mobile device may include a wireless network interface configured to provide a network connection without being physically connected to a network connection point.

In the example shown in FIG. 6, the computer 1000 includes a processing unit 1001 having one or more processors and a non-transitory computer-readable storage medium 1002 that may include, for example, volatile and/or non-volatile memory. The memory 1002 may store one or more instructions to program the processing unit 1001 to perform any of the functions described herein. The computer 1000 may also include other types of non-transitory computer-readable medium, such as storage 1005 (e.g., one or more disk drives) in addition to the system memory 1002. The storage 1005 may also store one or more application programs and/or resources used by application programs (e.g., software libraries), which may be loaded into the memory 1002.

The computer 1000 may have one or more input devices and/or output devices, such as devices 1006 and 1007 illustrated in FIG. 6. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 6, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with hardware (e.g., one or more processors) that is programmed using microcode or software to perform the functions recited above.

In this respect, it should be appreciated that one implementation of embodiments of the present disclosure comprises at least one computer-readable storage medium (i.e., at least one tangible, non-transitory computer-readable medium, e.g., a computer memory (e.g., hard drive, flash memory, processor working memory, etc.), a floppy disk, an optical disc, a magnetic tape, or other tangible, non-transitory computer-readable medium) encoded with a computer program (i.e., a plurality of instructions), which, when executed on one or more processors, performs above-discussed functions of embodiments of the present invention. The computer-readable storage medium can be transportable such that the program stored thereon can be loaded onto any computer resource to implement aspects of the present invention discussed herein. In addition, it should be appreciated that the reference to a computer program which, when executed, performs above-discussed functions, is not limited to an application program running on a host computer. Rather, the term “computer program” is used herein in a generic sense to reference any type of computer code (e.g., software or microcode) that can be employed to program one or more processors to implement above-discussed aspects of the present invention.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A system comprising:
at least one processor; and
at least one storage having encoded thereon executable instructions that, when executed by the at least one processor, cause the at least one processor to:
visually render a first view of at least one user interface element; and
in response to detecting a trigger event, cause the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

2. The system of claim 1, wherein the at least one processor is programmed by the executable instructions to render a transition animation of the at least one user interface element growing in size from the first view to the second view.

3. The system of claim 1, wherein:
the at least one user interface element comprises, at least, a first user interface component and a second user interface component.

4. The system of claim 3, wherein:
the first and second user interface components are present both in the first view and in the second view; and
a relative position between the first and second user interface components in the second view matches a relative position between the first and second user interface components in the first view.

5. The system of claim 4, wherein:
a distance between the first and second user interface components in the second view is larger than a distance between the first and second user interface components in the first view.

6. The system of claim 1, wherein the second view comprises at least one user interface component that is not visible in the first view.

7. The system of claim 1, wherein the trigger event is a first trigger event, and wherein the at least one processor is further programmed by the executable instructions to:
in response to detecting a second trigger event, cause the first view of the at least one user interface element to visually replace the second view of the at least one user interface element.

8. The system of claim 1, wherein the at least one user interface element comprises at least one control, and wherein the at least one processor is further programmed by the executable instructions to:
visually convey a state of the at least one control in the first view.

9. The system of claim 8, wherein the at least one processor is further programmed by the executable instructions to:
in response to a change in the state of the at least one control, update the first view to reflect the state of the at least one control.

10. The system of claim 1, wherein the executable instructions comprises a first set of instructions for rendering the first view and a second set of instructions for rendering the second view, the second set of instructions being independent from the first set of instructions.

11. The system of claim 10, wherein:
the executable instructions further comprises a third set of instructions for a super view;
the first set of instructions programs the at least one processor to render the first view based on the super view in a first manner; and
the second set of instructions programs the at least one processor to render the second view based on the super view in a second manner different from the first manner.

12. The system of claim 1, wherein:
the at least one processor is programmed by the executable instructions to receive, via the second view of the at least one user interface element, user input relating to at least one functionality; and
the at least one processor is not programmed to receive, via the first view of the at least one user interface element, user input relating to at least one functionality.

13. The system of claim 1, wherein the at least one processor is programmed to receive, via the first view of the at least one user interface element, only user input to trigger visual replacement of the first view by the second view.

14. The system of claim 1, wherein the at least one processor is programmed to render the first view within a viewport, the viewport comprising at least one visual feature other than the at least one user interface element, and wherein a size of the second view relative to the viewport is larger than a size of the first view relative to the viewport.

15. The system of claim 14, wherein the at least one processor is programmed to cause the first view to be visually replaced by the second view without changing the at least one visual feature other than the at least one user interface element.

16. The system of claim 1, wherein the at least one processor is programmed by the executable instructions to cause the second view to visually obscure the first view.

17. The system of claim 1, wherein the at least one processor is programmed by the executable instructions to:
in response to detecting the trigger event, cause at least one intermediate event to occur; and
cause the first view to be replaced visually by the second view in response to the at least one intermediate event.

18. The system of claim 17, wherein causing the at least one intermediate event to occur comprising setting a timer to expire after a selected duration of time.

19. The system of claim 1, wherein the at least one user interface element comprises a slider.

20. The system of claim 19, wherein the slider is configured to receive user input to control magnification of displayed text.

21. A method performed by at least one processor programmed by executable instructions, the method comprising:
visually rendering, on a display device, a first view of at least one user interface element; and
in response to detecting a trigger event, causing the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.

22. At least one computer-readable medium having encoded thereon executable instructions that, when executed by at least one processor, cause the at least one processor to perform a method comprising:
visually rendering, on a display device, a first view of at least one user interface element; and
in response to detecting a trigger event, causing the first view of the at least one user interface element to be replaced visually by a second view of the at least one user interface element, the second view being larger than the first view, wherein the trigger event comprises an event selected from a group consisting of: a user moving a pointer over the first view, a user clicking the first view, and a user touching the first view.
